(19) United States
(12) Patent Application Publication
(10) Pub. No.: US 2018/0138745 A1
(43) Pub. Date: May 17, 2018

(54) INDUCTIVE POWER TRANSFER APPARATUS WITH IMPROVED COUPLING

(71) Applicant: 3I INNOVATION LIMITED, Auckland (NZ)

(72) Inventor: Charles Darrell MAUD, North Shore City (NZ)

(21) Appl. No.: 15/567,218

(22) PCT Filed: Apr. 17, 2015
(86) PCT No.: PCT/NZ2015/050047

§ 371 Date: Oct. 17, 2017

(51) Int. Cl. H02J 50/10; H01F 38/14

(52) U.S. Cl. CPC H02J 50/10; H01F 38/14

(57) ABSTRACT

Apparatus for an Inductive power transfer system, particularly adapted for lighting systems such as road studs, includes a pick-up core (12) having a flange portion (30), and a receiver (20) which includes a recess (25) for locating a primary conductor (26).

### FIELD OF THE INVENTION

This invention relates to apparatus and systems for transferring power inductively i.e. wirelessly. Such systems are commonly known as inductive power transfer (IPT) systems. The invention has particular, but not sole, application to IPT systems having stationary pick-ups (otherwise known as secondaries). One application of the invention includes lighting systems for roadways.

The operation of inductive power transfer systems can be found in the prior art, for example in U.S. Pat. No. 7,675,197, the contents which are incorporated herein by reference.

As stated in U.S. Pat. No. 7,675,197, inductive power transfer systems have significant benefits in a number of applications. One such application is lighting systems for roadways, tunnels, swimming pools and aircraft. These systems generally have unfavourable environments for power distribution. For example roadways are subject to considerable physical stresses due to large fast moving vehicles, illuminated road studs that are powered using fixed or hard wired connections are difficult to wire into the roadway, and are prone to failure due to stresses from vehicles that can physically move the stud or the adjacent road surface and allow foreign matter such as water or dirt to interfere with the wired connections. Inductive power transfer systems have been used in environments such as roadways for some time now and have become a favoured solution.

One of the difficulties with IPT systems is providing good coupling between the primary conductive path (described in more detail below with reference to FIG. 1), and the pick up or pick-ups (i.e. the secondary units) to which power is transferred inductively from the primary conductors. For example, if the coupling between the primary and secondary is relatively weak, then an increased current is required in the primary conductors in order to provide sufficient field for reliable power transfer. The increased current means that a more expensive power supply is required. It also results in an increase in the size or quality of the primary conductors i.e. an increase in the amount of copper in the cable which has a direct cost on the overall cost of the installation since in some cases many kilometres of cable are required.

Similarly, on the secondary side, if there is poor coupling then more expense is required in terms of pick up coil and quality of the componentry in the pick-up devices.

Factors that lead to poor coupling between the primary and secondary include distance or spacing between the primary conductors and the pick-up devices, the design of the pick-up devices themselves, and damage to elements of the pick-up devices such as ferrite used to assist in intercepting the field from the primary conductors.

### OBJECT

It is an object of the present invention to provide an IPT system, method or components for such as system, that allow improved power transfer, or to at least provide the public the public with useful alternative to existing apparatus, systems and methods.

### BRIEF SUMMARY OF THE INVENTION

According to one aspect of the invention broadly consists in an IPT pick up magnetic core for stationary pick up apparatus, the core comprising a body adapted for location adjacent to a primary conductive path, and a flange means dependent from the body, the flange means adapted to receive magnetic flux from the primary conductive path and make the flux available to the body.

Preferably a pick up coil is provided magnetically associated with the body.

Preferably the flange means comprises of flange portion. In one embodiment the flange portion is provided one end of the body.

In another embodiment the flange means forms as recess for receiving a primary conductor.

In one embodiment the flange means is provided on selected parts of the body to provide one or more recesses whereby the body may be rotated relative to the primary conductor in order to dispose the primary conductor in the recess.

In another aspect the invention broadly provides an IPT system pick up including a magnetic core according to any one of the preceding statements.

In another aspect the invention broadly provides a light emitting unit comprising IPT pick up apparatus according to the preceding statement.

In one embodiment the light emitting unit comprises a road stud.

In yet another aspect the invention broadly provides an IPT pick up locator comprising a body having receiving means for receiving a part of a pick-up.

Preferably the apparatus includes means to locate a conductor of an IPT primary relative to the body.

In one embodiment the receiver means comprises a recess. Preferably the recess is adapted to receive a part of an IPT pick up.

In one embodiment the recess receives a magnetic core of the pick-up. Preferably the magnetic core includes a pick up coil. In some embodiments the magnetic core and/or the pick-up core may be encased in a casing which is also received in the recess.

In one embodiment the location means comprises one or mare elements dependent from the body or housing which are adapted to receive a primary conductor.

In another aspect the invention comprises a primary conductive pathway including a plurality of location devices according to the preceding statement.

In yet another aspect the invention broadly consists in an IPT primary power supply including a pathway according to the preceding statement.

In another aspect the invention broadly provides apparatus for providing magnetic flux concentration for reception by a stationary pick up, the apparatus comprising a pick-up receiver having a receiving means for receiving at least part of the pick-up apparatus, and location means for locating a primary conductor relative to the receiver.

In one embodiment the receiver comprises a housing or partial housing.

The invention may also broadly be said to consist in any individual novel parts or features described in this document, or any novel combinations of features described herein.

Further aspects of the invention will become apparent from the following description.

### DRAWING DESCRIPTION

One or more embodiments of the invention will now be described by way of example with reference to the accompanying drawings in which:

FIG. 1: is a diagram of a known IPT system topology;

FIG. 2: is a drawing in cross section showing one embodiment of apparatus for improved coupling between a primary conductor and a pick-up;

FIG. 3: is a drawing in cross section of another embodiment of apparatus including improved coupling between a primary conductor and a pick-up;

FIG. 4: is a drawing in cross section of another embodiment of apparatus including improved coupling between a primary conductor and a pick-up;

FIG. 5: is a drawing in cross section of another embodiment of apparatus including improved coupling between a primary conductor and a pick-up wherein the pick-up is disposed in a first orientation following initial relative location of the pick-up apparatus with a housing of a pick-up receiver;

FIG. 6: is a drawing in cross section of the embodiment of FIG. 5 but showing the pick-up disposed in another orientation in which it has been rotated 90 degrees relative to the receiver;

FIG. 7: is a drawing in cross section of another embodiment of apparatus including improved coupling between a primary conductor and a pick-up in which the pick-up is substantially the same as that shown in FIG. 2, but the receiver has means for accommodating multiple turns of a primary conductor;

FIG. 8: is a drawing in cross section of another embodiment of apparatus including improved coupling between a primary conductor and a pick-up in which the pick-up is substantially the same as that shown in FIG. 3, but the receiver has means for accommodating multiple turns of a primary conductor;

FIG. 9: is a drawing in cross section of another embodiment of apparatus including improved coupling between a primary conductor and a pick-up in which the pick-up is similar to that shown in FIG. 4, but has an extended skirt portion, and the receiver has means for accommodating multiple turns of a primary conductor;

FIG. 10: is a side view of an embodiment of a receiver apparatus according to the invention;

FIGS. 11 and 12: are isometric views of the receiver of FIG. 10;

FIG. 13: is an isometric view of the receiver of FIG. 10 and also shows primary conductors carried by, guided by, or engaged with the receiver.

### DETAILED DESCRIPTION

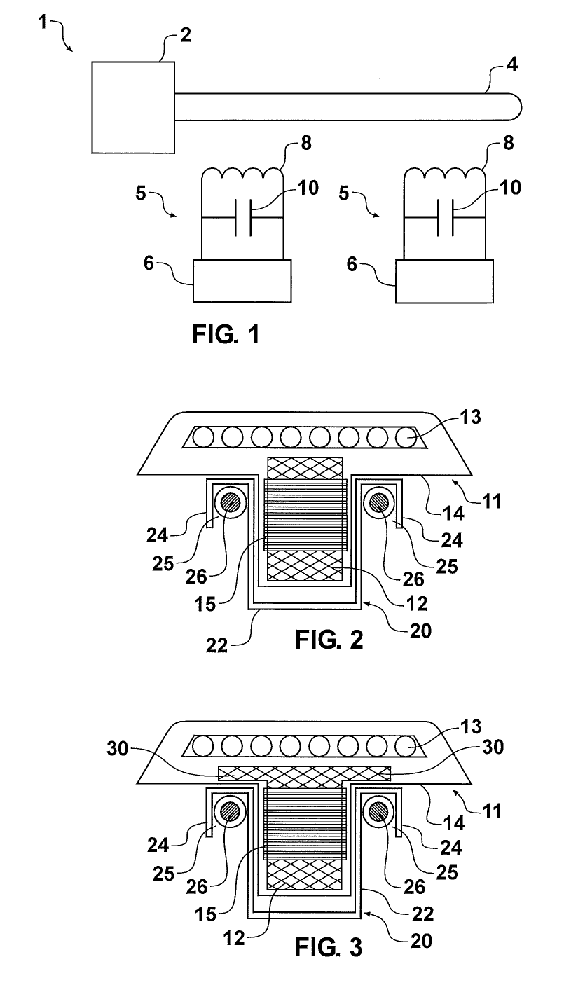

Referring to FIG. 1, the basic structure of an IPT power supply (also sometimes referred to as an inductively coupled power transfer (ICPT) power supply system or a contactless power supply system) is shown generally referenced 1. The system generally comprises two electrically isolated parts. The first part consists of a power supply 2 which may comprise a resonant converter for example. The power supply supplies electrical energy to a primary conductive path 4 so that an alternating current is provided in the primary conductive path. The primary conductive path is usually provided in the form of an elongated cable or track from which one or more of the second parts (commonly referred to as “pick-ups”) 5 are located. The primary conductive path may be provided on, within, or beneath a roadway for example, and secondary pick-ups 5 which may comprise lighting elements such as illuminated road studs are adhered to the surface of the roadway.

Each of the pick-ups 5 includes a pickup element such as a coil 8 which is located sufficiently close to the conductive path 4 (but not in direct electrical contact with the conductive path) to enable voltage to be induced wirelessly in the pick-up coil 8 by mutual induction. Reference to coils or windings in this document includes multiple turns of conductive material as well as a single turn or partial turn. The pick-up coils 8 are tuned with the tuning capacitor 10 to augment the power transfer capability from the primary conductive path to each pick-up. The tuning, although shown in FIG. 1 as being achieved with a parallel connected capacitor, may also be achieved with a series connected capacitor. It will also be understood that capacitance may be provided without having to provide a separate capacitive component.

The output from the tuned pickup circuit comprising elements 8 and 10 is then typically rectified and fed to a controller. Discussion of one example of an appropriate controller, and a description which provides more information about the function and construction of IPT systems generally may be found with reference to the U.S. Pat. No. 5,239,308. That document describes partial decoupling of the pick-up coil to control the power flow to match the power taken from the primary conductive path to that required by a load supplied by each pick-up 6.

Turning to FIG. 2, an embodiment of apparatus in the form of an illuminable road stud 11 which allows improved coupling between the primary conductor and a pick-up is shown in cross-section. The pick-up is illustrated diagrammatically. For ease of illustration the control circuit which is used to control the lights (in the form of LEDs in this example) 13 powered by the pick-up device is not illustrated. Those skilled in the art will appreciate that the pick-up may power a number of different devices depending on the desired application. For ease of explanation the following description will use the example of a powered road stud, and those skilled in the art will appreciate that this is merely one example.

The road stud pick-up assembly includes a core or similar body 12 of highly magnetically permeable material such as ferrite. In use, the light emitting elements 13 of a road stud may be located on top of the core 12 for example, but other arrangements are possible. Furthermore, the core 12 may be encased in a further casing in addition to housing 14 of the apparatus. In one embodiment the additional casing is constructed from a plastic material. The housing and/or the additional casing ensure the core 12 is protected from the surrounding environment.

The casing and/or housing 14 can also serve to prevent the core 12 from disintegrating should the core crack or break in use. This is a significant benefit in the case of a road stud in which brittle (and expensive) ferrite tends to fracture and disintegrate when subjected to stresses from heavy moving vehicles. Lack of ferrite leads to reduced coupling of the pick-up circuit and failure of the road stud 11.

The housing 14 may also carry a pick-up coil 15 (equivalent to coil 8 in the system described with reference to FIG. 1) which is in use tuned as described above. For example, the coil 15 is embedded or encased in the plastics material from which housing 14 is also formed. Alternatively, the coil 16 can be attached to, or relative to, the core 12 in other ways, for example by adhering it to the core.

Still referring to FIG. 2, the road stud 11 is received in a receiver generally referenced which has a housing 22 adapted to receive at least part of the road stud or pick-up apparatus contains core 12 of the pick-up. The receiver 20 is in use located in a body of material such as a roadway. The LED's 13 sit above the roadway when the road stud 11 is located in the receiver 20 as shown in the drawing FIGS. 2-9 so that the LED's 13 are visible to traffic using the roadway.

The housing 22 may in some embodiments comprise a partial housing which simply has sufficient structure, for example a recess or receiving region 21 to locate the road stud 11 or other pick-up apparatus relative to the roadway or other substrate material in which it is placed in use. In other embodiments the housing 22 encloses a significant portion of the pick-up to protect it from the surrounding environment and/or to locate the pick-up securely relative to the roadway. The apparatus may be used in other applications, for example swimming pool lights, in which the receiver 20 may instead be located in a wall of the pool and the pick-up powers a light rather than road-stud LED's 13.

In some embodiments the housing 22 also has a primary conductor location means 24 to locate the primary conductor 26 (equivalent to conductor 4 of FIG. 1) relative to the roadway and/or the pick-up. The location means can in some embodiments consist of a channel or slot or recess 25, and in other embodiments may consist of a fingers or resilient elements which capture the conductors 26 sufficiently to maintain the necessary spatial relationship between the conductors 26 and the core 12 and/or coil 15 of pick-up assembly.

Thus the primary conductor 26 (which in this example comprises a loop of cable) may be placed in a slot cut in the roadway, and the two adjacent sides of the conductor are separated so as to lie either side of the core 12 in the vicinity of the core. In the prior art the relative location of the conductors and the pick-up is imprecise and can be somewhat arbitrary which can lead to inconsistent performance and failure.

As can be seen in FIGS. 2 to 4, the receiver 20 allows the primary conductor 26 to be held in position in the roadway and closely adjacent to the core 12, and to be located at the correct position for efficient provision of magnetic flux to the coil 15.

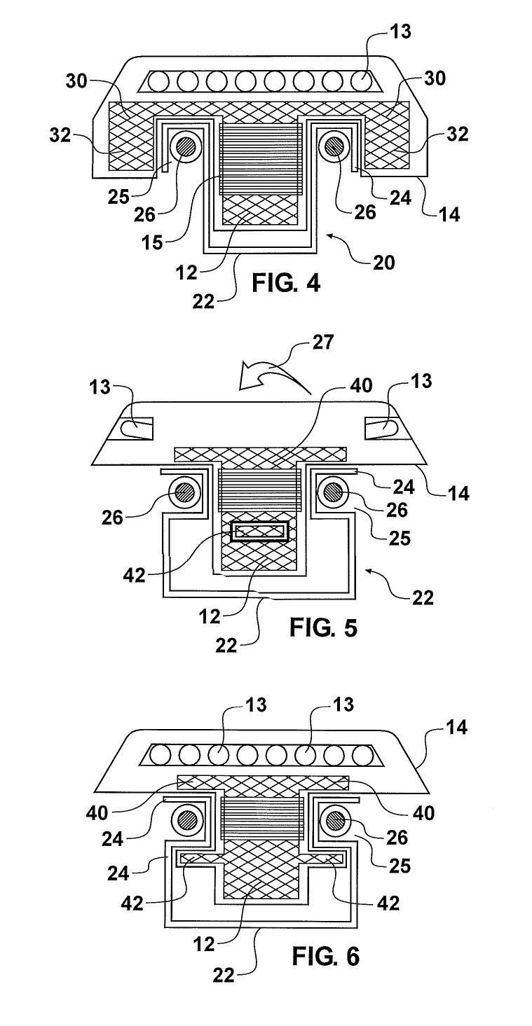

Turning now to FIG. 3 it will be seen that the core 12 has a flange portion 30 which is part of, or at least magnetically associated with, the core 12. Thus the flange 30 is preferably also constructed from a highly magnetically permeable material such as ferrite. Flange 30 may extend about the entire periphery of the core 12 or about a selected portion, or portions, of the core. We have found that use of a flange portion significantly improves coupling when provided in at least the vicinity of primary conductors 26. The flange portion 30 may extend from the core 12 to a greater or lesser extent than that shown in the drawing Figures.

A further development is shown in FIG. 4 in which the flange portion 30 has a dependent skirt portion 32. Again, in some embodiments the skirt portion may not be continuous, and in practice it will be desirable for there to be an opening in the skirt for the conductors 26 to enter and exit the recess formed by the skirt between the skirt and the core 12. Magnetic coupling is further enhanced by the skirt portion 32.

Turning now to FIG. 5, an embodiment is shown in which the flange portion 30 comprises two upper flange portions 40. Two lower flange portions 42 are also provided. In use, the core 12 of the pick-up is initially disposed as shown in FIG. 5 so that the flange portions 40 and 42 are aligned with the longitudinal axis of the conductors 26. This allows the pick-up to be lowered into the housing 22 of the receiver so that the flange portions 40 and 42 fit between the separated conductors 26. Once the position shown in FIG. 5 is achieved, the core 12 is then rotated through 90 degrees as shown by arrow 27 to the position shown in FIG. 6, so that the flange portions sandwich the conductors i.e. the conductors 26 are disposed in the recesses formed by the flange portions 40 and 42 and the relevant external portions of the core 12. This arrangement also allows improved coupling.

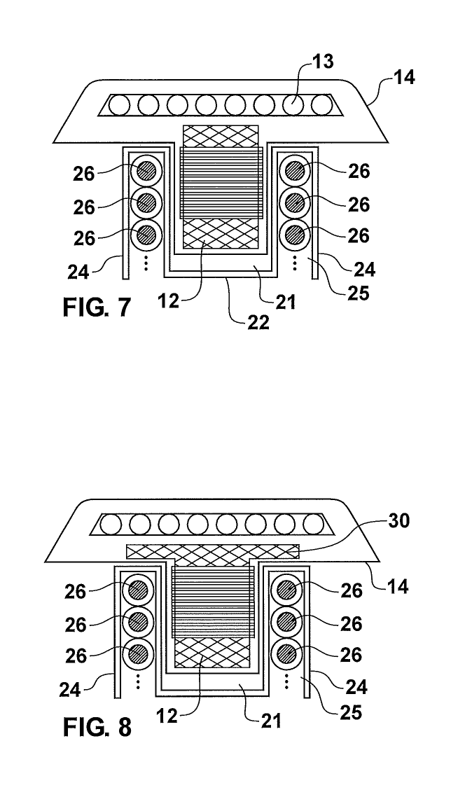

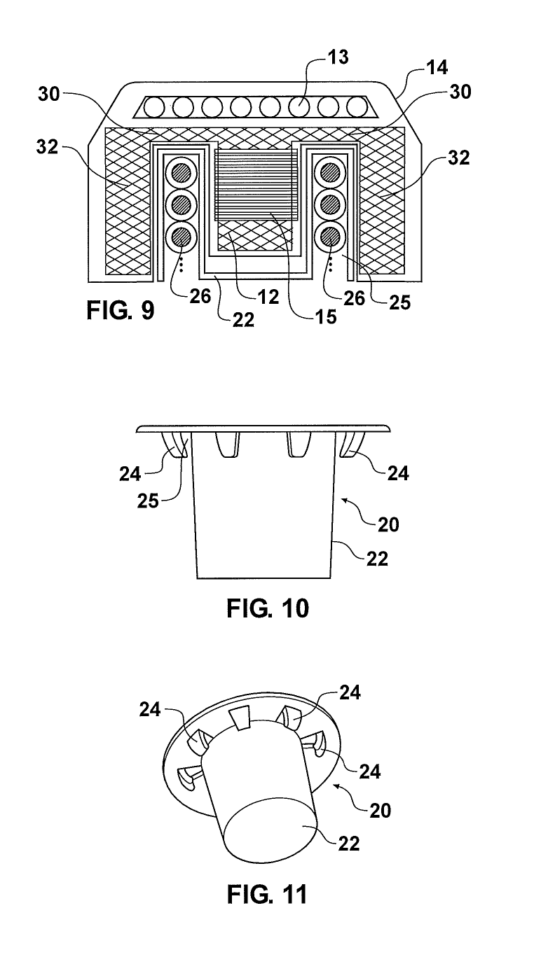

Turning to FIGS. 7 to 9 the location means 24 in these embodiments is configured to allow multiple turns of conductor 26 to be located relative to the housing, and thus provided in an efficient position relative to core 12 for coupling. This multiple turn arrangement further enhances coupling. The coils 15 can also be extended on the cores 12 as shown in the Figures. Finally, as can be seen in FIG. 9, skirt portion 32 can be extended to further increase coupling. It will be seen that the embodiment of FIGS. 5 and 6 can also be applied to the multiple turn arrangement of this embodiment.

A plan view of the apparatus shown in FIGS. 2-9 has not been illustrated because the apparatus my be any desired shape e.g. circular, square, hexagonal, or even in some embodiments irregular shapes may be used.

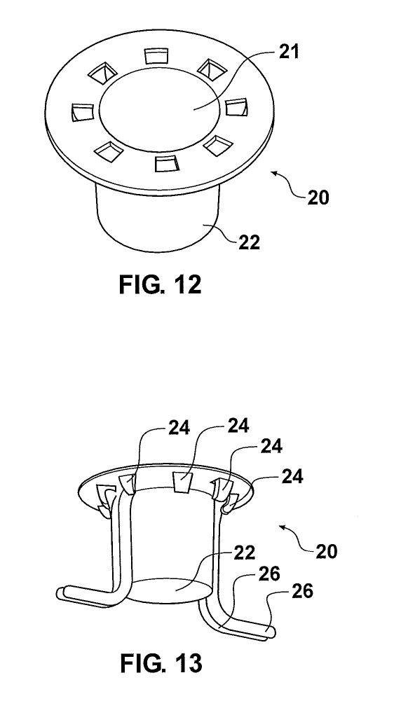

Turning now to FIGS. 10-13, one embodiment of a receiver is shown in which the location means 24 comprise a plurality if fingers which are shaped (and may be resilient) to receive, accommodate and/or retain conductors 26 which are energised in use by a primary power supply.

Those skilled in the art will see that the features described above will allow easier, faster and more reliable installation of pick-up devices, and will allow improved coupling and thus greater efficiencies and lees cost.

In this document, the word “comprise” and variations such as “comprises” and “comprising” is intended to have an inclusive meaning (i.e. as meaning “including, but not limited to”) unless the context clearly requires the contrary.

1. An Inductive power transfer (IPT) pick up magnetic core for stationary pick up apparatus, the core comprising a body adapted for location adjacent to a primary conductive path, and a flange means dependent from the body, the flange means adapted to receive magnetic flux from the primary conductive path and make the flux available to the body.

2. An IPT pick-up magnetic core as claimed in claim 1 further comprising a pick up coil provided magnetically associated with the body.

3. An IPT pick-up magnetic core as claimed in claim 1 wherein the flange means comprises a flange portion.

4. An IPT pick-up magnetic core as claimed in claim 3 wherein the flange portion is provided at one end of the body.

5. An IPT pick-up magnetic core as claimed in claim 1 wherein the flange means forms as recess for receiving a primary conductor.

6. An IPT pick-up magnetic core as claimed in claim 1 wherein the flange means is provided on selected parts of the body to provide one or more recesses whereby the body may be rotated relative to the primary conductor in order to dispose the primary conductor in the recess.

7. An IPT pick-up including a magnetic core according to claim 1.

8. A light emitting unit comprising IPT pick-up apparatus according to claim 7.

9. A light emitting unit as claimed in claim 8 wherein the light emitting unit comprises a road stud.

10. A stationary IPT pick-up locator comprising a body having receiving means for receiving a part of an IPT pick-up.

11. A stationary locator as claimed in claim 10 further comprising means to locate a conductor of an IPT primary relative to the body.

12. A stationary locator as claimed in claim 10 wherein the receiver means comprises a recess.

13. A stationary locator as claimed in claim 12 wherein the recess is adapted to receive a part of an IPT pick-up.

14. A stationary locator as claimed in claim 12 where in the recess receives a magnetic core of the pick-up.

15. A stationary locator as claimed in claim 10 wherein the IPT pick-up comprises a road stud.

16. A roadway including one or more stationary IPT pick-up locations as claimed in claim 10.

17. (canceled)

18. An IPT pick-up magnetic core as claimed in claim 2 wherein the flange means comprises a flange portion.

19. An IPT pick-up magnetic core as claimed in claim 2 wherein the flange means forms as recess for receiving a primary conductor.

20. An IPT pick-up magnetic core as claimed in claim 2 wherein the flange means is provided on selected parts of the body to provide one or more recesses whereby the body may be rotated relative to the primary conductor in order to dispose the primary conductor in the recess.

21. An IPT pick-up including a magnetic core according to claim 2.
